(19) United States
(12) Patent Application Publication
(10) Pub. No.: US 2005/0076076 A1
(43) Pub. Date: Apr. 7, 2005

(54) Collaborative logistics information exchange method and apparatus

(75) Inventor: Robert Bruce Galbraith, Simpsonville, SC (US)

Correspondence Address: DORITY & MANNING, P.A., POST OFFICE BOX 1449, GREENVILLE, SC, 29602-1449, US

(73) Assignee: Liberty Logistics Inc.

(21) Appl. No.: 10/914,612

(22) Filed: Aug. 9, 2004

Related U.S. Application Data
(60) Provisional application No. 60/493,481, filed on Aug. 8, 2003.

(51) Int. Cl. G06F 15/16

(52) U.S. Cl. 709/200

(57) ABSTRACT

Disclosed is an apparatus and methodology for collaborative logistics information exchange that permits the entry, storage, retrieval and viewing of data pertinent to the transportation of freight loads or product coordinated through a logistics broker and/or his agent(s). Information exchange may be conducted over a local or wide area network or the Internet substantially in real time and may include capabilities of storing and transmitting images of selected paper documents, conducting instant messaging sessions and attaching load relevant electronic notes to selected stored information.

### CROSS REFERENCE TO RELATED APPLICATIONS

This application claims priority to Provisional Patent Application U.S. Ser. No. 60/493,481, entitled “Collaborative Logistics Information Exchange Environment And System” filed Aug. 8, 2003, which is fully incorporated herein by reference.

### FIELD OF THE INVENTION

The present subject matter relates to methods and apparatus for the exchange of information from logistic brokers and their agents to their clients. The present subject matter also pertains to methods for permitting access to information, possibly by way of the Internet, by contracted carriers who may be interested in hauling loads on behalf of a broker.

### BACKGROUND OF THE INVENTION

Logistics brokers are individuals who arrange for the transportation of products or goods for their clients, possibly manufacturers, from one location to another. The departure point for such transportation may be a manufacturing facility, warehouse or other facility, while the destination may be a distribution center, retail sales establishment, or other location. At present logistics brokers expend a great deal of effort maintaining computerized databases permitting information exchange between the broker and his or her client(s). By maintaining such computerized databases, the logistics broker is able to supply his clients with limited information regarding freight loads or shipments that the client has committed to the broker to move for the client. Although the databases are computerized, data entry is a manual process and the entire process is paper driven.

These computerized databases and systems, while useful, are limited in that they do not currently provide any mechanism to allow a client to track their freight loads as they are picked up and/or delivered. At present, clients must rely on the broker to furnish this information either by paper documents in the form of mailed or faxed documents, by telephone, or through some other form of direct communication. Also the paper work that is associated with these loads (Bill of Lading and Pick and Delivery) must be mailed or faxed before clients can invoice the load to their customers.

In addition to a lack of load tracking capability, there are a number of other areas of interest to both the logistics broker and clients that are not presently being addressed. This is due in part to the inadequacies of the computer systems currently being used and to the fact that existing systems have not utilized wide area or globally available communications systems such as wide area networks, Intranets, or the Internet to provide information exchange between brokers and their clients. Were such wide area communications capabilities available, logistics brokers and their clients might be spared from investing excessive of time, energy, and financial resources in building and maintaining information exchange interfaces or an Internet presence.

Logistics based systems are, in general, known, however the known systems are limited in that they provide only a broker to client relationship. Moreover known systems impose burdens on Logistics Brokers and/or their agents in that they do not permit real time information or real time documentation so that clients may know their freight load locations.

While various implementations of logistics information exchange systems have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved methodology and system is provided for communicating logistic freight load information between Logistics Brokers and/or their agents and their clients. The methodology and system in accordance with the present technology may be provided as a subscription, private, or public service and may be configured for use in association with a local area network (LAN), a wide area network (WAN), an Intranet or the globally accessible Internet.

In accordance with one aspect of certain embodiments of the present technology a methodology is provided for authorizing selected individuals to be given access to certain types of logistic load information that may be proprietary or confidential in nature. Such authorization permits control over issues including confidentiality of information, intrusion by idle curiosity seekers and the general public and approach by unwanted business solicitors.

In accordance with another aspect of certain embodiments of the present technology, methodologies are provided to insure that individuals having unethical or criminal motives would not be allowed to use logistic freight load information to their wrongful advantage.

In accordance with yet another aspect of certain embodiments of the present technology methodologies are provided for establishing necessary criteria for qualifying a client to receive freight logistic load information by first establishing a business relationship between a logistics broker and a client.

In accordance with a further aspect of certain embodiments of the present technology a prospective client may be permitted to view certain other client's information if it is appropriate for the broker to provide a prospective client with this information and the broker has obtained the approval of the client, either directly or inferentially.

In accordance with yet a further aspect of certain embodiments of the present technology a methodology and system is provided to allow clients to view all paper work pertaining to a freight load by freight load basis including allowing the client to view the signed Bill of Lading, pick paper work, and delivery paper work and, in turn, print out, and invoice their customer.

In accordance with yet still a further aspect of certain embodiments of the present technology a methodology and system is provided to allow clients to view an activity listing of current undelivered loads and their expected time of pickup and delivery, as well as an activity listing of delivered freight loads that provides the time and date of delivery as well as online documentation for each freight load delivered the same day it is delivered. Online availability of such information relieves the broker from having to manually provide such valuable information to his clients.

Additional aspects of the present technology are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a Block Diagram flowchart view of a collaborative logistics information exchange usable over the Internet and an Intranet;

FIG. 2 is a Block Diagram flowchart illustrating the manual entry process of feight load data into the database of the collaborative logistics information exchange;

FIG. 3 is a Block Diagram flowchart of the client website of the collaborative logistics information exchange;

FIG. 4 is a Block Diagram flowchart of the carrier website of the collaborative logistics information exchange;

FIG. 5 is a network flowchart of the brokers internal LAN of the collaborative logistics information exchange; and

FIG. 6 is a network flowchart of the brokers WAN of the collaborative logistics information exchange.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with collaborative logistics information exchange methodologies and systems configured to permit the exchange of information between involved parties relating to aspects concerning the transportation of product from one location to another.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

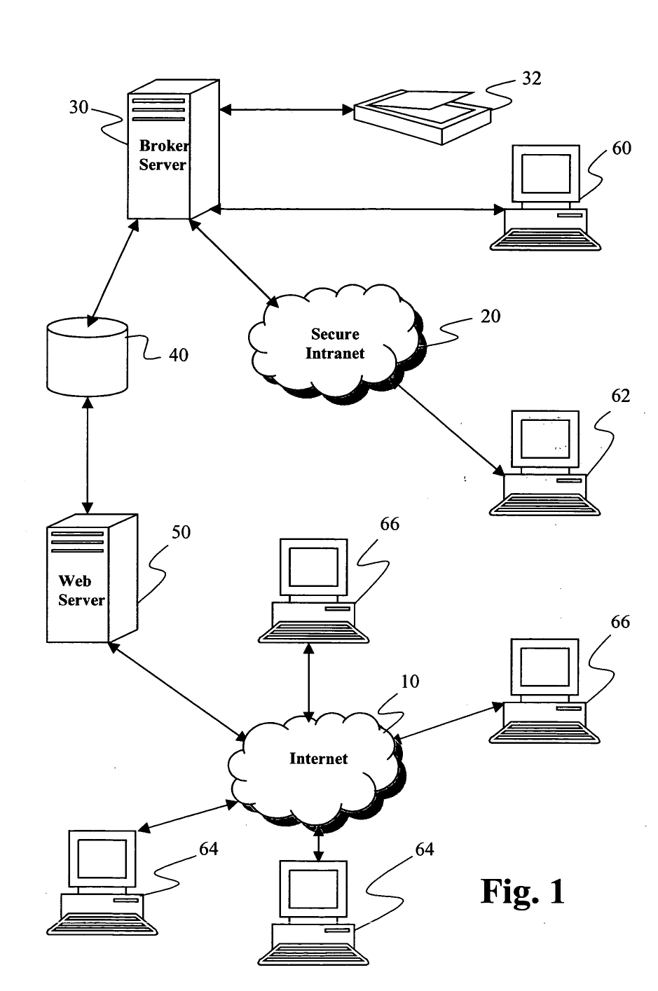

Reference will now be made in detail to the presently preferred embodiments of the present technology referring on occasion to all of the drawings and in particular now to FIG. 1 wherein is illustrated a block diagram system overview of a collaborative logistics information exchange in accordance with the present technology. A network coupling the various components of the collaborative logistics information exchange may include the Internet 10 as well as a Local Area Network (LAN) 20, sometimes also referred to as an Intranet. Only a small representation of the Internet 10 is shown, as it is well understood that the Internet 10 is quite expansive and expandable.

Broker server 30 is electronically connected to the Internet 10 or other wide area network by way of database 40 and Web Server 50. Broker server 30 is configured to communicate with other computers and peripheral devices including, for example, facsimile or scanner device 32, that may also be connected to the network comprising the collaborative logistics information exchange, as is well understood in the art.

Broker server 30 is configured for access to database 40, which it updates and maintains as new, relevant information is received by way of the collaborative logistics information exchange network. Database maintenance, updates and additions and/or information retrieval may be carried out by a number of users connected to the network by way of user workstations. These workstations may include a Broker workstation 60, one or more authorized agent's workstation 62, one or more client workstations 64, 64 and one or more carrier workstations 66, 66. Selected of the various workstations are permitted access to certain of the information fields or files that may be stored in the database 40 or which are compiled by the broker server 30 during its operation. As should be apparent to those of ordinary skill in the art, any number of these types of users by way of appropriate workstations may be granted controlled access to the system comprising the collaborative logistics information exchange network.

Normally, Clients and authorized carriers must be under contract with the broker and/or his agent(s) in order to be permitted access to the system. Listing the clients and carriers on a register or table of clients and carriers in database 40 may be reflective of granting select clients and carriers access to the collaborative logistics information exchange network. Other types of users, for example data entry, computer system analysts, and other types of software specialists may also be granted specialized access capabilities as needed to enter data and to service the collaborative logistics information exchange system, as is well known in the computer arts although not specifically described herein. As should be apparent to those of ordinary skill in the pertinent art, the number of various users of the collaborative logistics information exchange network may be multiplied as necessary and required to accommodate overall system and network requirements.

Referring again to FIG. 1, a generally block diagram has been illustrated showing features that govern overall system operation for any given activity. It is noted that all of the various figures and flowcharts provided herein are supplied for general information purposes sufficient to provide an enabling disclosure to one skilled in the computer programming and system arts, but are not necessarily discussed in detail unless it is to illustrate a particular feature of the system. Some of the figures will provide greater detail of the system features and operation. A review of the figures and flowcharts is intended to disclose an exemplary methodology in which the various features and capabilities of the system may be provided. Obviously, other ways may become apparent to those having ordinary skill in the programming arts upon review of the present disclosure.

FIG. 1 illustrates an exemplary broker intranet site wherein data regarding various freight loads is entered into the collaborative logistics information exchange network. After information is received from contracted clients, relevant data is entered via a broker workstation 60 or agent workstation 62 into the system based on a menu selection made by the workstation user.

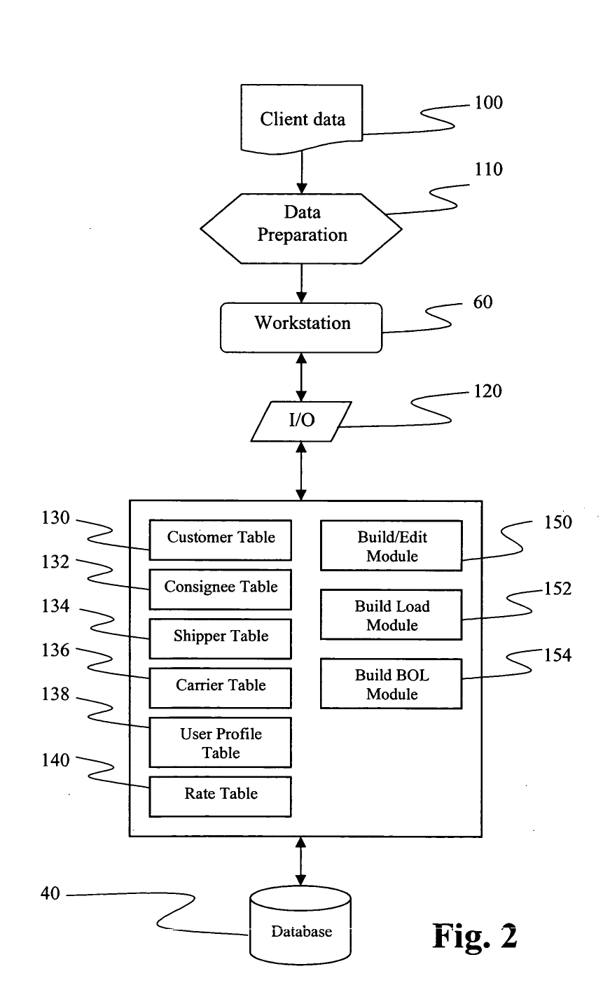

With reference now to FIG. 2, illustrated is an exemplary configuration of the operational configuration of the data entry and maintenance aspects of the broker server operation. As outlined in FIG. 2, client information 100 may be collected and compiled or prepared 110 in preparation for manual entry of the data at, for example the broker workstation 60. Of course other workstations such as an agent workstation 62 (FIG. 1) possibly over a connection through the secured intranet 20 or via a LAN or WAN may be used for data entry purposes. Once saved the information is stored in database 40. In an exemplary implementation database 40, although not limited thereto, may comprise an “Open DataBase Connectivity” (ODBC) compliant database, ODBC being a standard database access method developed by Microsoft Corporation.

Generally information may be submitted by a client including the following: Client customer information, Shipper Identification, Receiver (consignee) Information, Item codes, UPC codes of the product being shipped and the quantities of each, Date(s) for pick up of freight, Date(s) for delivery of freight, Weight of total shipment, Total number of pieces in freight load, Total number of pallets in freight load, and Base rate for shipment based on rates agreed to by Broker (or agent) and client.

FIG. 2 diagrammatically illustrates the various subroutines or modules available within the software programming operating on the broker server 30 for inputting and manipulating data, selection of individual ones of which may be based on a menu selection. Build/Edit module 150 may be selected to start inputting the freight information supplied from the client as above enumerated. The user entering the supplied data will select from the various tables 130, 132, 134, 136, 138, and 140 to build a freight load. If appropriate data has not been previously entered in the tables the user can input the needed data in the tables based on the information provided from the client and then select them in the Build/Edit module 150. Once client data has been entered the user selects the Build BOL Module 152 to record bill of lading information and inputs the various item codes and/or UPC codes into the system that have been provided for the freight load from the client. Following entry of these data, the user may select the Build Load Module 152 from a menu listing and then select the base rate from the Rate Table 140 assigned to the client. At this point the load is available to bid out to the various carriers within the system. The user may then schedule pickup and delivery times with the shipper and consignee and input these data into the appropriate fields in the system. Once a carrier has accepted the rates offered the user chooses the carrier from the Carrier Table 136. The freight load is now ready to be tracked.

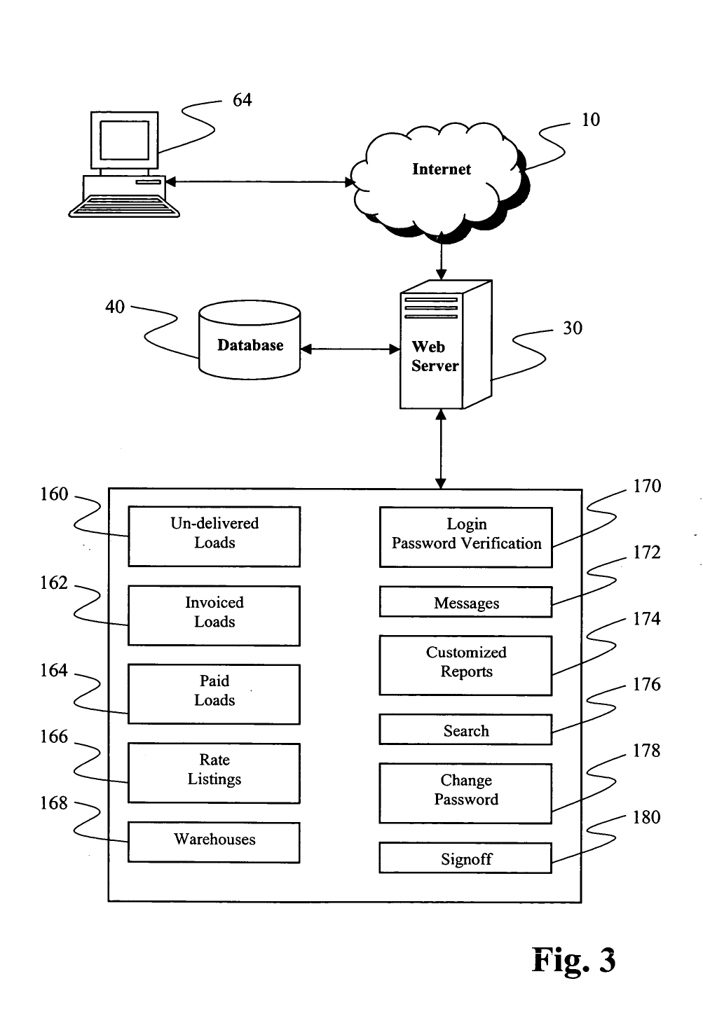

With reference now to FIG. 3, illustrated is an exemplary layout of an operational configuration of a client workstation's functional relationship within the collaborative logistics information exchange network. The client, by way of a client workstation 64 is able to view information from the client website and is able to obtain information regarding freight loads assigned to the broker. They can view the detail of the load and see the pickup and delivery dates and times for the load. Also the freight paperwork they have submitted to the broker is scanned into the system and is available to view as one of the miscellaneous documents associated with the load. As illustrated in FIG. 3, a number of subroutines or modules 160-180 are provided within the client website providing various load information including information regarding un-delivered loads 160, invoiced loads 162, paid loads 164, rate listings 166 and warehouses 168. In addition a search capability 174, customized report capability 172 and security functions including login/password verification 170, password maintenance 176 and a signoff subroutine 178. An additional capability available through client workstation 64 is a messages module 172 that gives clients the ability to pass instant messages to the broker and/or his agents.

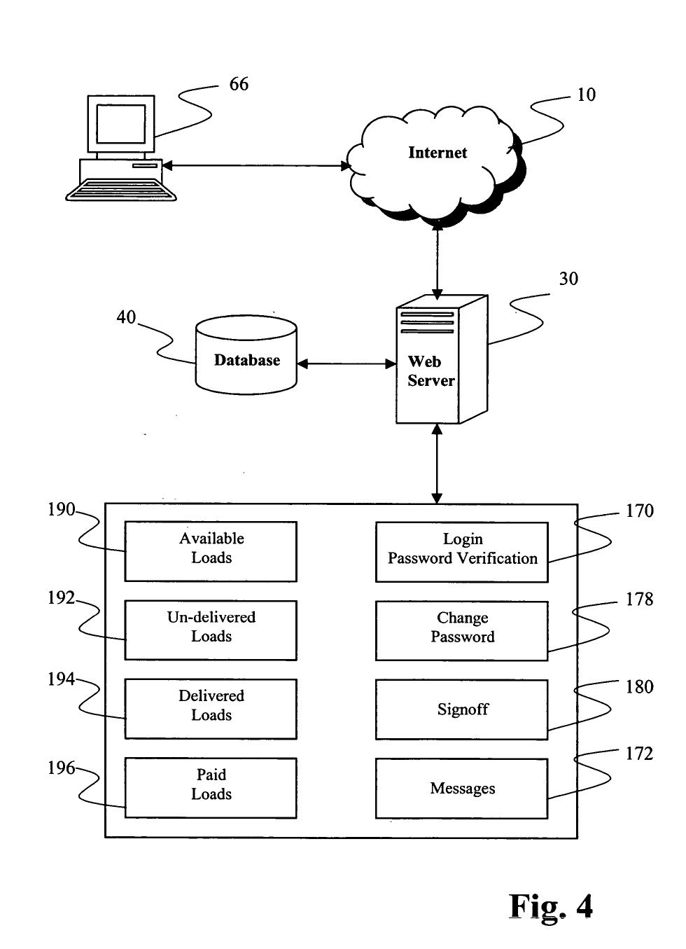

With reference to FIG. 4, illustrated is an exemplary layout of an operational configuration of a carrier workstation's functional relationship within the collaborative logistics information exchange network. A carrier, by way of carrier workstation 66 is able to view information from the carrier website and may obtain information regarding loads previously assigned to him as well as available loads to determine if there is a new load available that meets their needs. If such a load is found, the carrier can contact the broker or his agent and request to be assigned to the load. Carriers also have the capabilities to send an instant message 196 to the broker and may use that capability to ask to be assigned a particular freight load as well as to exchange other messages with the broker and/or his agents. Once an instant message is keyed into the system from either the client or the carrier a message bar is highlighted in the system to indicate to the broker and/or his agents that a message has been sent. Any of the broker associates (broker or his agents) can read the message and respond to the message and reply to the sending party.

As illustrated in FIG. 4, a number of subroutines or modules 190-196 are provided within the carrier website that mirror similar subroutines available on the client website. These subroutines provide various load information including information regarding available loads 190, un-delivered loads 192, delivered loads 194, and paid loads 196. In addition security functions including login/password verification 170, password maintenance 178 and a signoff subroutine 180 are available that are substantially equivalent subroutines as those provided for the client website. Security aspects associated with the login/password operation limit the information available to any one carrier to their own information to the exclusion of information related to other carriers who may also use the collaborative logistics information exchange network.

After a freight load has been picked up from the shipper the carrier calls the broker and relays information regarding time the carrier was loaded and if any fee's were charged during the loading process. This information is then keyed into the appropriate fields in the collaborative logistics information exchange system for that particular freight load. Once the freight load has been delivered to the consignee the carrier calls in the delivery information to the broker. The carrier also transmits by facsimile all the paperwork relating to the freight load to a specific fax number set up on the collaborative logistics information exchange system. A broker associate goes into the system and then attaches all the information to the appropriate load as well as the appropriate data fields on the delivery time. The associates also have the capability to enter notes regarding the load. These notes are for the client to see if there were any issues with the load or other information that the broker may deem necessary for the client or carrier to see.

Once load information has been entered into the system the client can view details of the complete load, e.g. when it shipped, when it delivered, and any load notes associated with the load. With the documents that are attached with the load the client can bring up the documents to view as well as print the documents at their local printer. These documents may include the signed Bill of Lading that the carrier faxed into the system at the broker site. Details regarding any particular load may be maintained within the collaborative logistics information exchange system for a predetermined period of time, for example, for one year, after which such older information may be moved to an archival location for more or less permanent storage or retrieval as necessary.

The client also has the capability from the client website (FIG. 3) to view other pertinent information such as Un-delivered Loads 160, Invoiced Loads 162, Paid Loads 164, and Rate Listings 166. Security aspects associated with the login/password operation limit the information available to any one client to their own information to the exclusion of information related to other clients who may also use the collaborative logistics information exchange network. At the client's request customized reports 174 can be made available on the site. From the client website the client can use the instant messaging system 172 to request rates that are not already on the rate listing table 166 for new freight loads or to inquire on existing freight loads from the said broker. A special feature of the present technology is that the instant messaging system is configured such that the Broker is automatically notified thereby if one of his clients accesses the collaborative logistics information exchange network.

The contracted carriers can also go to the carrier website (FIG. 4) and once their logon and password are verified be able to look at various information based on the menu selection on the site. The carrier is able to view the Available Loads 190 that displays all the available freight loads stored in the collaborative logistics information exchange system from all clients whose loads were entered into the system. If a carrier wishes to be assigned to one of the freight loads they can examine the stored information regarding the freight load and are provided the capability to send a message to the broker indicating their interest in being assigned to the load. The message comes into the broker and has the freight load number attached that the carrier was inquiring about. The carrier can also view all un-delivered loads 192 these are freight loads they have been assigned to by the broker. They can also view all delivered freight loads 194 these are freight loads they have already delivered and will show them when they can expect payment for the freight load. They can also view all paid freight loads 196 they have completed for the broker.

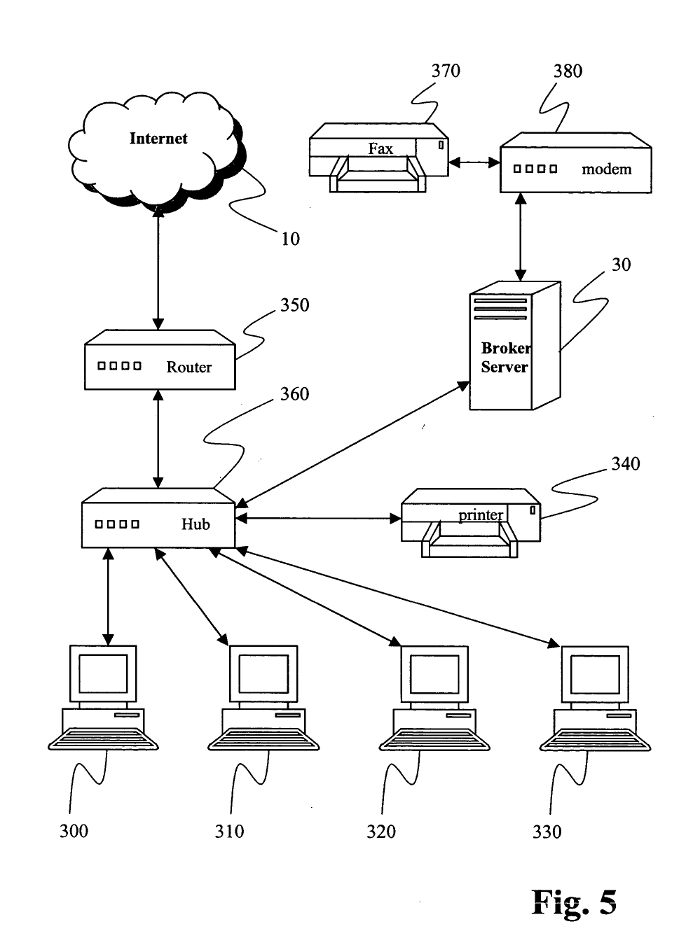

FIG. 5 is an exemplary diagrammatic representation of a local area network (LAN) or Intranet configuration for a Broker office. The illustrated system is capable of handling any number of workstations as represented by workstations 300-330 as well as other peripheral devices including in a non-limiting manner, printer 340, facsimile machine 370 and modem 380. Although only a single server 30 is illustrated, multiple servers may be employed depending on the workload at the Broker office. FIG. 5 also illustrates in a general manner the methodology whereby a connection to the Internet 10 is established using a secured fire walled router 350 and hub 360.

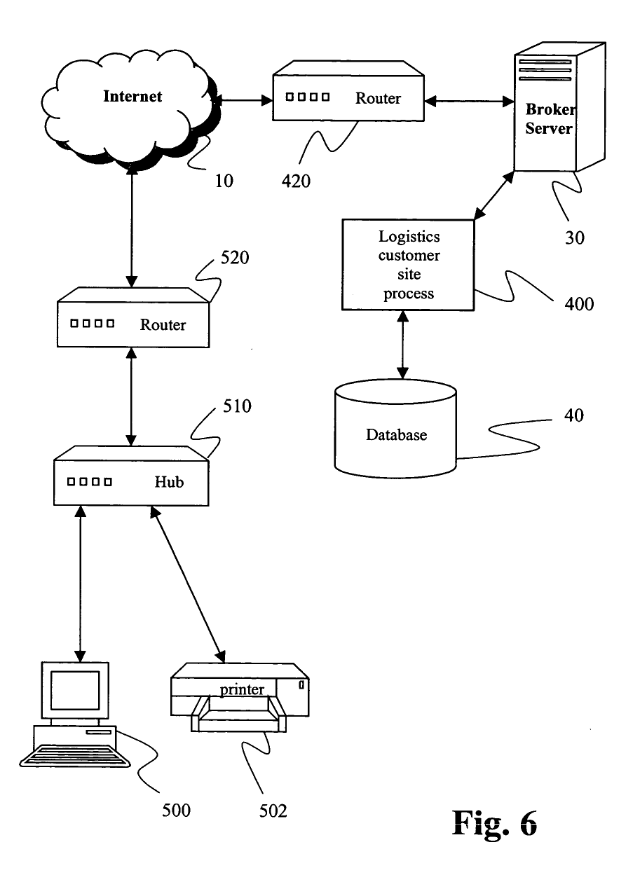

FIG. 6 is an exemplary diagrammatic representation illustrating the methodology for connecting a client and carrier through the Internet 10 by way of the Broker Server 30. The broker side of the connection includes a wide area network (WAN), local area network (LAN) or Intranet coupled to the Internet by way of router 420 that contains data stored in database 40 and supplies information and customer driven processes 400 in the form of various subroutines operating on Broker Server 30 to the Internet 10 side of the website for the clients and the carriers. Note that Broker customers correspond to at least clients and carriers. FIG. 6 illustrates only a single workstation 500 and printer 502 connected to the Internet 10 by way of hub 510 and router 520 but it should be clearly understood that such is representational only and that the system is capably of handling multiple users at multiple workstations each using their own printers and other peripherals at any one time.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A collaborative logistics information exchange system, comprising:
a broker server configured to provide information exchange and data processing capability;
a data storage device coupled to said broker server;
at least one broker workstation;
at least one client workstation;
at least one carrier workstation; and
a network coupling said broker, client and carrier workstations to said broker server,
wherein said broker server is configured to enable entry and retrieval of data via one or more of said broker, client and carrier, workstations relating to the transportation of product from one location to another and wherein said broker server is configured to provide instant messaging capability between at least individual pairs of broker, client and carrier workstations.

2. A collaborative logistics information exchange system as in claim 1, further comprising:
a security subroutine configured within: the data processing capability of said broker server, said security routine selectively limiting access to information exchangeable between selected ones of client workstations and carrier workstations and said broker server.

3. A collaborative logistics information exchange system as in claim 2, further comprising:
a menu driven information entry and retrieval subroutine configured within the information exchange capability of said broker server, said menu driven information entry and retrieval subroutine providing selected levels of data entry and retrieval capability in dependence on whether an accessing workstation is a broker, client or carrier workstation.

4. A collaborative logistics information exchange system as in claim 3, wherein said network is a wide area network.

5. A collaborative logistics information exchange system as in claim 3, wherein said network is the Internet.

6. A collaborative logistics information exchange system as in claim 1, wherein the broker server is configured to provide specialized instant messaging capability wherein an instant message initiated from selected workstations is automatically transmitted to a plurality of selected workstations, whereby a response to the instant message may be provided from any one of said plurality of selected workstations.

7. A method for collaboratively exchanging logistics information, comprising the steps of:
establishing an information repository and processing center;
establishing a plurality of information entry and retrieval centers;
coupling said information repository and processing center and said plurality of information entry and retrieval centers together for information transfer;
providing selective information entry and retrieval capabilities for selected ones of the plurality of information entry and retrieval centers; and
providing an instant messaging capability between selected pairs of the plurality of information entry and retrieval centers.

8. The method of claim 7, further comprising the step of providing a specialized instant messaging capability between selected ones of the plurality of information entry and retrieval centers and selected pluralities of the plurality of information entry and retrieval centers.

9. The method of claim 7, further comprising the step of automatically transmitting a predetermined message to one or more selected of the plurality of information entry and retrieval centers upon occurrence of a predetermined activity at selected of said plurality of information entry and retrieval centers.

10. The method of claim 7 wherein the step of coupling comprises coupling said information repository and processing center and said plurality of information entry and retrieval centers together over a wide area network.

11. The method of claim 7 wherein the step of coupling comprises coupling said information repository and processing center and said plurality of information entry and retrieval centers together over the Internet.
